(19) United States
(12) Patent Application Publication
(10) Pub. No.: US 2025/0328988 A1
(43) Pub. Date: Oct. 23, 2025

(54) DOWNSCALING OF SATELLITE THERMAL IMAGES

(71) Applicant: International Business Machines Corporation, Armonk, NY (US)

(72) Inventor: David Alec Selby, Nr Fareham (GB)

(21) Appl. No.: 18/673,880

(22) Filed: May 24, 2024

(30) Foreign Application Priority Data
Apr. 22, 2024 (GB) 2405634.3

(51) Int. Cl. G06T 5/50; G06T 7/90

(52) U.S. Cl. CPC G06T 5/50; G06T 7/90; G06T 2207/10036; G06T 2207/10048; G06T 2207/20076

(57) ABSTRACT

A method, system, computer program for determining a metric at a second resolution, comprising: acquiring a first set of spectral values from a first satellite at a first resolution; determining a set of indices at the first resolution and a metric at the first resolution from the first set of spectral values, wherein the set of indices comprises: NDVI; NDWI; NDBI; NDSI; and NBRI; determining a model linking the metric at the first resolution with the set of indices at the first resolution; acquiring a second set of spectral values from a second satellite at the second, the second resolution finer than the first resolution; determining a second set of indices at the second resolution from the second set of spectral values; and applying the second set of indices to the model to determine the metric at the second resolution.

### TECHNICAL FIELD

The invention is generally directed to environmental analysis. In particular it provides a method, system, computer program product and a computer program for determining a metric at a location.

### BACKGROUND ART

Understanding a thermal footprint of a building is important to allow for environmental, social, and corporate governance.

Customers are seeking to understand how to reduce energy costs and improve their carbon footprint. Heating loss from building is a major concern for many.

However, tools to understand which buildings in the portfolio to prioritize is a concern.

Landsat 8 and 9 satellites are equipped with both optical and thermal sensors. The optical sensors are at 30 m resolution. The thermal sensors are 100 m resolution, but data is provided downscaled to 30 m by interpolation.

The resolution on Landsat 8 and 9 thermal infrared bands is too coarse to be able to evaluate anything but a very large building. Therefore, a derived land surface temperature (LST) is also limited to a low resolution. To be effective a way is needed to downscale the data so the spatial resolution can be improved.

The problem is especially difficult in urban environments, as patterns of land cover are complex.

Onac̆illová, Katarina & Gallay, Michal & Paluba, Daniel & Péliová, Anna & Tokarc̆ik, Ondrej & Laubertová, Daniela. (2022). “Combining Landsat 8 and Sentinel-2 Data in Google Earth Engine to Derive Higher Resolution Land Surface Temperature Maps in Urban Environment”. Remote Sensing. 14. 4076. 10.3390/rs14164076, makes use of the known relationship between LST and land over metric, such as normalized difference vegetation index, built-up index (NDBI), and water index (NDWI). A multiple linear regression is defined based on the spectral indices and LST from Landsat 8 data to inform the same model in which the equivalent spectral indices derived from Sentinel-2 are used to predict LAT at 10 m resolution.

https://www.sciencedirect.com/science/article/abs/pii/S092427162030232X. “Global comparison of diverse scaling factors and regression models for downscaling Landsat-8 thermal data”, Dong, P. et al. ISPRS Journal of Photogrammetry and Remote Sensing”, Vol 169, November 2020, compares 35 SDLST algorithms derived from a combination of seven scaling factors and five frequently used regression models over 32 geographical regions worldwide. The seven scaling factors, at varying degrees, make use of the LST-related information embedded within the visible and near-infrared and short-wave infrared bands of Landsat-8 data. The five regression models involved are multiple linear regression, partial least squares regression, artificial neural networks, support vector regression, and random forest (RF).

“Applicability of Downscaling Land Surface Temperature by Using Normalized Difference Sand Index”, Xin Pan et al. Scientific Reports 9530 (2018) discloses that Land surface temperature (LST) in coarse spatial resolution derived from thermal infrared satellite images has limited use in many remote sensing applications. In this study, a multiple remote-sensing index approach of random forest approach is improved to downscale LST derived from Landsat 8 and MODIS in an arid oasis by designing a normalized difference sand index (NDSI), by the removal of land cover datasets and by the input of SAVI, NDBI and NDWI to downscale LST. Such an approach was designed for desert conditions.

In addition to thermal resolution, there is also a need to analyze CO₂ emissions from buildings at a fine resolution. CO₂ emissions have been shown to correlated well with thermal characteristics.

However existing methods need improvement to make more accurate analyses at greater resolutions.

Therefore, there is a need in the art to address the aforementioned problem.

### SUMMARY OF INVENTION

According to the present invention there are provided a method, a system, and a computer program product according to the independent claims.

Viewed from a first aspect, the present invention provides a computer implemented method for determining a metric at a second resolution at a location, the method comprising: gathering a first set of spectral values from a first satellite at a first resolution for the location in a first time period, the first set of spectral values comprising a value from a thermal band; determining a set of indices at the first resolution and the metric at the first resolution from the first set of spectral values, wherein the set of indices comprises: NDVI; NDWI; NDBI; NDSI; and NBRI; determining a model linking the metric at the first resolution with the set of indices at the first resolution; acquiring a second set of spectral values from a second satellite at the second resolution for the location for the first time period, the second resolution finer than the first resolution; determining the set of indices at the second resolution from the second set of spectral values; and applying the second set of indices to the model to determine the metric at the second resolution.

Viewed from a further aspect, the present invention provides a system for determining a metric at a second resolution at a location, the system comprising: a gather component for gathering a first set of spectral values from a first satellite at a first resolution for the location in a first time period, the first set of spectral values comprising a value from a thermal band; a first indices component for determining a set of indices at the first resolution and the metric at the first resolution from the first set of spectral values, wherein the set of indices comprises: NDVI; NDWI; NDBI; NDSI; and NBRI; a model component for determining a model linking the metric at the first resolution with the set of indices at the first resolution; the gather component for gathering a second set of spectral values from a second satellite at the second resolution for the location for the first time period, the second resolution finer than the first resolution; a second indices component for determining the set of indices at the second resolution from the second set of spectral values; and an apply component for applying the second set of indices to the model to determine the metric at the second resolution.

Viewed from a further aspect, the present invention provides a computer program product for determining a metric at a second resolution at a location, the computer program product comprising a computer readable storage medium having program instructions embodied therewith, the program instructions executable by a processor to cause the processor to: gather a first set of spectral values from a first satellite at a first resolution for the location in a first time period, the first set of spectral values comprising a value from a thermal band; determine a set of indices at the first resolution and the metric at the first resolution from the first set of spectral values, wherein the set of indices comprises: NDVI; NDWI; NDBI; NDSI; and NBRI; determine a model linking the metric at the first resolution with the set of indices at the first resolution; acquire a second set of spectral values from a second satellite at the second resolution for the location for the first time period, the second resolution finer than the first resolution; determine the set of indices at the second resolution from the second set of spectral values; and apply the second set of indices to the model to determine the metric at the second resolution.

Viewed from a further aspect, the present invention provides a computer program product for managing a storage system, the computer program product comprising a computer readable storage medium readable by a processing circuit and storing instructions for execution by the processing circuit for performing a method for performing the steps of the invention.

Viewed from a further aspect, the present invention provides a computer program stored on a computer readable medium and loadable into the internal memory of a digital computer, comprising software code portions, when said program is run on a computer, for performing the steps of the invention.

Preferably, the present invention provides a method, system, computer program product and computer program, wherein the first satellite comprises a Landsat satellite, and the second satellite comprises a Sentinel satellite.

Preferably, the present invention provides a method, system, computer program product and computer program, wherein the metric comprises Land Surface Temperature, and the thermal band comprises Landsat band 10.

Preferably, the present invention provides a method, system, computer program product and computer program, wherein the metric comprises CO₂ and the thermal band comprises Landsat band 11.

Preferably, the present invention provides a method, system, computer program product and computer program, wherein the set of indices further comprises at least one from a list, the list comprising: EVI; SAVI; NDMI; MSI; GCI; BSI; and ARVI.

Preferably, the present invention provides a method, system, computer program product and computer program, wherein the method further comprises: choosing a list item based on analyzing climate of the location.

Preferably, the present invention provides a method, system, computer program product and computer program, wherein determining a model comprises applying a multivariable regression line.

Preferably, the present invention provides a method, system, computer program product and computer program, wherein determining a model comprises applying a random forest algorithm.

Preferably, the present invention provides a method, system, computer program product and computer program, further comprising generating an image based on the metric at the second resolution.

Advantageously, the present invention improves the resolution of Landsat 8 & 9 and Sentinel-2 thermal images down to 10 m using known indices for NDSI and NBRI to improve the effectiveness of the linear regression model to select the best thermal channel to determine heat loss from a building, as demonstrated by the improvement in MAPE value.

Advantageously multi-variable regression is used, because the output coefficients can be easily applied to the Sentinel-2 image calculated indices. In other embodiments models are developed using other methods, such as Random Forest.

One of the two available bands correlates with C02 emissions so can be used as a proxy contrasting emission across the portfolio.

Note the results are relative rather than absolute due to the downscaling methodology.

Advantageously, the algorithms also easily identify large solar arrays either ground mount or on warehouses.

Advantageously, Landsat 8 & 9 Thermal images at 100 m (interpolated to 30 m by NASA) are downscaled to 10 m to be fine enough to assess building fabrics.

### BRIEF DESCRIPTION OF THE DRAWINGS

The present invention will now be described, by way of example only, with reference to preferred embodiments, as illustrated in the following figures:

FIG. 1 depicts a computing environment 100, according to an embodiment of the present invention;

FIG. 2 depicts a high-level exemplary schematic flow diagram 200 depicting operation methods steps for evaluating a metric at a location of interest 304, according to a preferred embodiment of the present invention;

FIG. 3 depicts the location of interest 304, according to a preferred embodiment of the present invention;

FIG. 4 also depicts a map of the location of interest 304, according to a preferred embodiment of the present invention;

FIG. 5 depicts software components 500 used, according to a preferred embodiment of the present invention; and

FIG. 6 depicts an annotated map 600 of the location 304 after processing, according to a preferred embodiment of the present invention.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

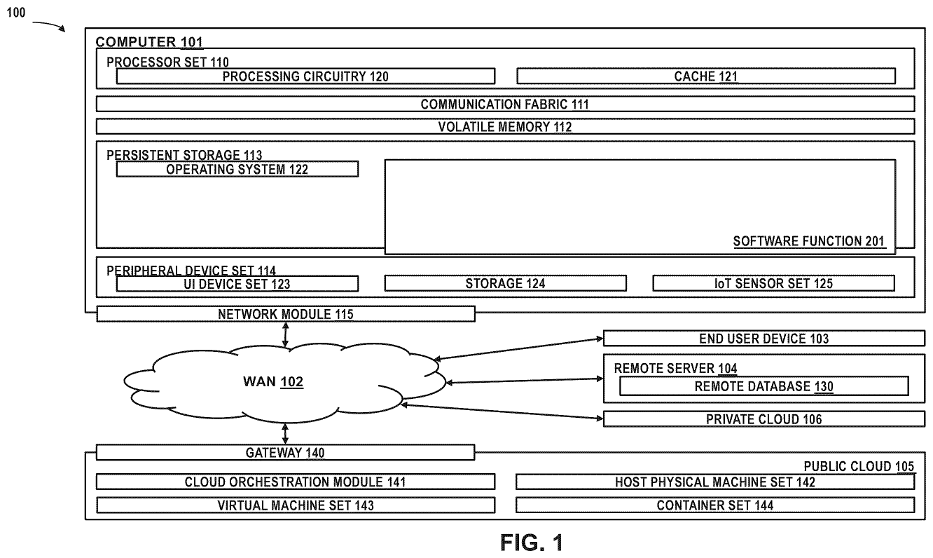

FIG. 1 depicts a computing environment 100. Computing environment 100 contains an example of an environment for the execution of at least some of the computer code involved in performing the inventive methods, such as software functionality 201 for improved processing of thermal images. In addition to block 201, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 201, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 201 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 201 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard disk, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

‘Downscaling’ environmental data refers to the process of increasing the spatial resolution of the original environmental imagery to obtain finer details. Typically, environmental data is derived from satellites. The present invention will be described in terms of satellite data, but the skilled person will understand that the invention could be applied to other sources of environmental data. Increasing the spatial resolution is made so as to match the resolution of other data sources or to improve the quality of analysis in remote sensing applications.

There are a number of techniques for downscaling. Examples include physical models, spatial-spectral fusion models, dynamical downscaling models, machine learning (ML) models, data assimilation models, and statistical models. For example, statistical models can refer to a one pass operation, whereas in ML models an iterative process takes place to learn a set of weights which can then be subsequently applied. Equally for a decision tree, a set of split points in features being analysed are learned.

Statistical downscaling of Land Surface Temperature (LST) involves using regression models or other statistical techniques to establish relationships between low-resolution LST data and high-resolution environmental variables. The models are then re-applied to the low-resolution LST data to establish interpolated high-resolution LST values.

The United States Geological Survey (USGS) and the National Aeronautics and Space Administration (NASA) Landsat satellite constellation of multiple satellites also provides coverage of the Earth's land surface. Landsat 8 and Landsat 9 comprises two sensors: the Operational Land Imager (OLI) and the Thermal InfraRed Sensor (TIRS). Landsat 8, 9, Landsat 8 and 9 satellites are equipped with both optical and thermal sensors. The optical sensors are at 30 m resolution. The thermal sensors are 100 m resolution, but data is provided downscaled to 30 m by interpolation.

TABLE 1
Landsat 8/9 bands

| | Wavelength (nm) | Resolution/meter |
|---|---|---|
| Band 1 - New deep blue | 433-453 | 30 |
| Band 2 - Blue | 450-515 | 30 |
| Band 3 - Green | 525-600 | 30 |
| Band 4 - Red | 630-680 | 30 |
| Band 5 - Near infrared | 845-885 | 30 |
| Band 6 - Shortwave infrared 2 | 1560-1660 | 30 |
| Band 7 - Shortwave infrared 3 | 2100-2300 | 30 |
| Band 8 - Panchromatic | 500-680 | 15 |
| Band 9 - Shortwave infrared | 1360-1390 | 30 |
| Band 10 - Thermal 1 | 10,600-11,190 | 100 (resampled |
| | | at 30) |
| Band 11 - Thermal 2 | 11,500-12,510 | 100 (resampled |
| | | at 30) |

The European Space Agency (ESA) Copernicus Sentinel-2 satellite constellation of multiple satellites provides coverage of the Earth's land surface (56° S to 84° N) with a satellite revisit frequency of every 10 days. Sentinel-2 satellites capture imagery in 13 spectral bands, each with its own spatial resolution. However, Sentinel-2 does not record thermal radiance at the surface.

Resolution refers to the area on the ground represented by a single pixel of the image. For example, with 10-meter resolution, a single pixel represents an area of 10×10 meters.

TABLE 2
Sentinel-2 bands

| | Wavelength (nm) | Resolution/meter |
|---|---|---|
| Band 1 - Coastal aerosol | 433-453 | 60 |
| Band 2 - Blue | 458-523 | 10 |
| Band 3 - Green | 543-578 | 10 |
| Band 4 - Red | 650-680 | 10 |
| Band 5 - Red edge 1 (RE1) | 698-713 | 20 |
| Band 6 - Red edge 2 (RE2) | 733-748 | 20 |
| Band 7 - Red edge 3 (RE3) | 773-793 | 20 |
| Band 8 - NIR | 785-900 | 10 |
| Band 8A - Narrow NIR | 855-875 | 20 |
| Band 9 - Water vapour | 935-955 | 60 |
| Band 10 - SWIR - Cirrus | 1360-1390 | 60 |
| Band 11 - SWIR | 1565-1655 | 20 |
| Band 12 - SWIR | 2100-2280 | 20 |

Data is also available from the Moderate Resolution Imaging Spectroradiometer (MODIS) instruments onboard the Terra and Aqua satellites. MODIS provides data in 36 spectral bands ranging in wavelength from 0.4 μm to 14.4 μm.

### Indices

A number of well-known indices have been developed to focus on specific aspects of study. Examples of indices are: NDVI; NDWI; NDBI; NDSI; and NBRI.

The skilled person would understand that there are many other indices that have been developed for particular purposes. For example, EVI, SAVI, NDMI, MSI, GCI, BSI and ARVI.

The following abbreviations are used:
NIR is the reflectance or brightness value in the near-infrared band.
SWIR is the reflectance or brightness value in the shortwave infrared band (Sentinel-2 band 11, Landsat 8/9 band 6).
Green is the reflectance or brightness value in the green or near-infrared band.
Red is the reflectance or brightness value in the red band.
Blue is the reflectance or brightness value in the blue band.
a is a coefficient that helps correct for atmospheric effects.
G_{EVI} is the gain factor (typically set to 2.5).
C₁ is the aerosol resistance factor (typically set to 6).
C₂ is the aerosol resistance factor (typically set to 7.5).
Lₑᵥᵢ is the canopy background adjustment factor (typically set to 1).
L_{SAVI} is the soil adjustment factor, typically set to a value between 0 and 1.

### 1. NDVI

Normalized Difference Vegetation Index (NDVI) is a spectral index commonly used in remote sensing to describe vegetation density and assessing changes in plant health.

NDVI is calculated using measurements from two spectral bands: one in the near-infrared (NIR) range and another in the Red range.

$$NDVI = ( N I R - Red ) / ( N I R + Red ) \qquad Equation 1$$

NDVI values typically range from −1 to 1, with higher values indicating dense and healthy vegetation, and lower values indicating sparse or unhealthy vegetation, bare soil, or non-vegetated surfaces. Specifically:

NDVI values close to 1 indicate dense, healthy vegetation cover. NDVI values close to 0 indicate sparse vegetation cover or bare soil. NDVI values close to −1 indicate non-vegetated surfaces, such as water bodies or urban areas.

NDVI is widely used in various applications, including agriculture, forestry, environmental monitoring, and land use planning.

### 2. NDWI

Normalized Difference Water Index (NDWI) It is a spectral index commonly used in remote sensing to detect and quantify the presence of water bodies or moisture content in vegetation. Sentinel-2 uses near infrared (NIR) and Green wavelengths.

$${NDWI}_{A} = ( ( Green - N I R ) / ( Green + N I R ) ) . \qquad Equation 2 A$$

Another version of the index uses near infrared (NIR) and short-wave infrared (SWIR) wavelengths.

$${NDWI}_{B} = ( N I R - S W I R ) / ( N I R + S W I R ) \qquad Equation 2 B$$

NDWI close to 1 indicates the presence of water bodies, as water absorbs near-infrared radiation and reflects shortwave infrared radiation. NDWI close to 0 indicates the absence of water, such as dry land or non-vegetated surfaces.

### 3. NDBI

Normalized Difference Built-Up Index (NDBI) is a spectral index used in remote sensing to detect and assess the extent of built-up or urban areas in satellite imagery. The NDBI is calculated using measurements from two spectral bands: one in the near-infrared (NIR) range and another in the shortwave infrared (SWIR) range.

$$NDBI = ( S W I R - N I R ) / ( S W I R + N I R ) \qquad Equation 3$$

The NDBI values typically range from −1 to 1, with higher values indicating a greater proportion of built-up or urban areas, and lower values indicating non-built-up areas, such as vegetation or water bodies. Specifically:

NDBI values close to 1 indicate dense urban areas with little vegetation cover. NDBI values close to 0 indicate areas with a balanced mix of built-up and non-built-up features.

NDBI values close to −1 indicate non-built-up areas, such as vegetation or water bodies.

NDBI is widely used in urban planning, land use mapping, and environmental monitoring.

### 4. NDSI

Normalized Difference Snow Index (NDSI) is a spectral index used to identify and map the presence of snow and ice cover in satellite imagery. The NDSI is calculated using measurements from two spectral bands: one in the visible or near-infrared range, and another in the shortwave infrared range.

$$NDSI = ( Green - SWIR ) / ( Green + SWIR ) \qquad Equation 4$$

NDSI values typically range from −1 to 1, with higher values indicating the presence of snow or ice cover, and lower values indicating the absence of snow or ice. Positive values indicate the presence of snow or ice, while negative values indicate the absence. NDSI is particularly useful in remote sensing applications for monitoring seasonal snow cover, glacier extent, and ice concentrations in polar regions.

### 5. NBRI

Normalized Burn Ratio Index (NBRI) is a spectral index commonly used in remote sensing to detect and assess the severity of burned areas or wildfires in satellite imagery. The NBRI is calculated using measurements from two spectral bands: one in the near-infrared (NIR) range and another in the shortwave infrared (SWIR) range. NBRI uses the NIR and SWIR bands to emphasize burned areas, while mitigating illumination and atmospheric effects.

$$NBRI = ( ( NIR - SWIR ) / ( NIR + SWIR ) ) \qquad Equation 5$$

The NBRI values typically range from −1 to 1, with higher values indicating a greater severity of burned areas or wildfires. Positive NBRI values indicate areas with vegetation loss due to burning, while negative values indicate healthy vegetation or unburned areas.

NBRI is widely used in wildfire monitoring, post-fire assessment, and ecological studies.

### 6. EVI

Enhanced Vegetation Index (EVI) is a vegetation index used in remote sensing to quantify the density and health of vegetation cover on the Earth's surface. It is an improved version of the Normalized Difference Vegetation Index (NDVI) and is designed to minimize atmospheric and background noise, particularly in regions with dense vegetation or high levels of aerosols.

EVI is calculated using measurements from multiple spectral bands, including the blue, red, and near-infrared ranges.

$$EVI = {G}_{EVI} \times ( ( NIR - Red ) / ( NIR + {C}_{1} \times Red - {C}_{2} \times Blue + {L}_{EVI} ) \qquad Equation 6$$

EVI values typically range from −1 to 1, with higher values indicating denser and healthier vegetation cover.

### 7. SAVI

Soil Adjusted Vegetation Index (SAVI) is another vegetation index used in remote sensing to quantify vegetation density and health, particularly in areas with sparse vegetation cover or in regions where soil background influences vegetation reflectance.

$$SAVI = ( ( NIR - Red ) \times ( 1 + {L}_{SAVI} ) / ( NIR + Red + {L}_{SAVI} ) \qquad Equation 7$$

L_{SAVI} is used to correct for soil brightness effects, which can vary depending on factors such as soil moisture, texture, and color. By adjusting the vegetation index calculation to account for soil brightness,

SAVI values typically range from −1 to 1, with higher values indicating denser vegetation cover.

### 8. NDMI

Normalized Difference Moisture Index (NDMI) is a spectral index commonly used in remote sensing to assess vegetation moisture content or water stress. NDMI is calculated using measurements from two spectral bands: one in the near-infrared (NIR) range and another in the shortwave infrared (SWIR) range.

$$NDMI = ( ( NIR - SWIR ) / ( NIR + SWIR ) ) \qquad Equation 8$$

Similar to other normalized difference indices, NDMI values typically range from −1 to 1. Higher values indicate higher vegetation moisture content or lower water stress, while lower values indicate lower moisture content or higher water stress.

### 9. MSI

MSI is sensitive to increases in leaf water content. The index is inverted relative to the other water vegetation indices; higher values indicate greater water stress and less water content. The values of this index range from 0 to more than 3. The common range for green vegetation is 0.4 to 2.

$$MSI = SWIR / NIR \qquad Equation 9$$

### 10. GCI

Green Chlorophyll Index (GCI) is used to estimate the content of leaf chlorophyll in various species of plants.

$$GCI = ( NIR / Green ) - 1 \qquad Equation 10$$

### 11. BSI

Bare Soil Index (BSI) includes blue, red, near infrared and short wave infrared spectral bands to capture soil variations. The short wave infrared and the red spectral bands are used to quantify the soil mineral composition, while the blue and the near infrared spectral bands are used to enhance the presence of vegetation.

$$BSI = ( ( Red + SWIR ) - ( NIR + Blue ) ) / ( ( Red + SWIR ) + ( NIR + Blue ) ) \qquad Equation 11$$

### 12. ARVI

Atmospherically Resistant Vegetation Index (ARVI) is another vegetation index used in remote sensing to quantify vegetation health and density while minimizing the effects of atmospheric conditions, such as aerosols and haze.

$$ARVI = ( NIR - ( Red - a ( Blue - Red ) ) ) / ( NIR + ( Red - b ( Blue - Red ) ) ) \qquad Equation 12$$

By incorporating the blue band and adjusting for atmospheric effects using the coefficient a, ARVI aims to provide more accurate estimates of vegetation health and density, particularly in areas with high levels of atmospheric interference. ARVI values typically range from −1 to 1, with higher values indicating denser vegetation cover.

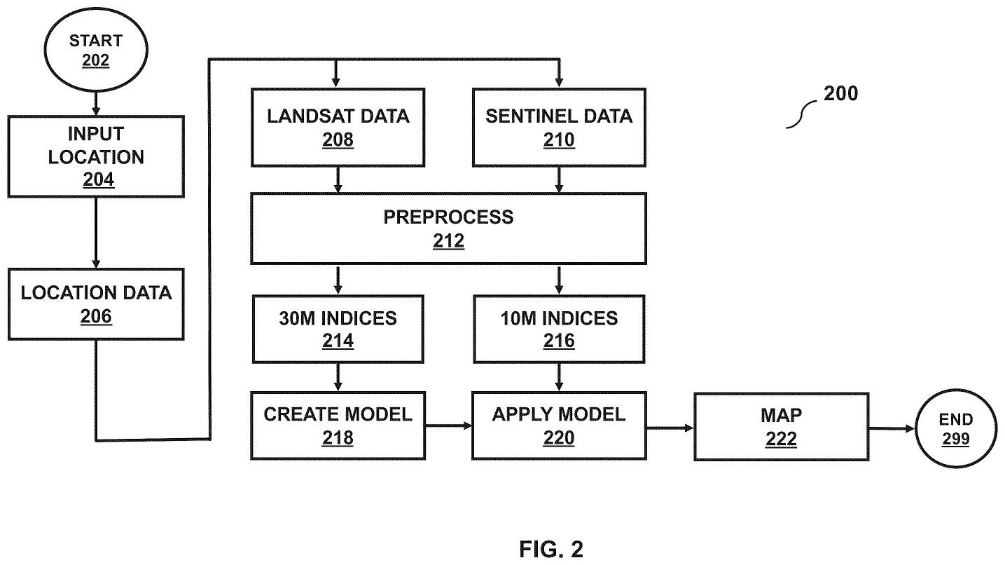

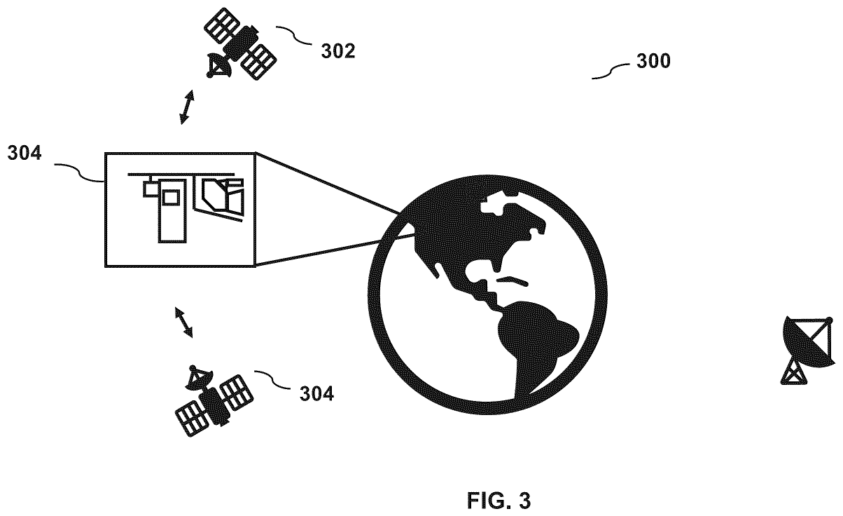

FIG. 2, which should be read in conjunction with FIGS. 3 to 8, depicts a high-level exemplary schematic flow diagram 200 depicting operation methods steps for evaluating a metric at a location of interest 304, according to a preferred embodiment of the present invention.

FIG. 3 depicts an environment 300 showing satellites 302 and the location of interest 304, according to a preferred embodiment of the present invention.

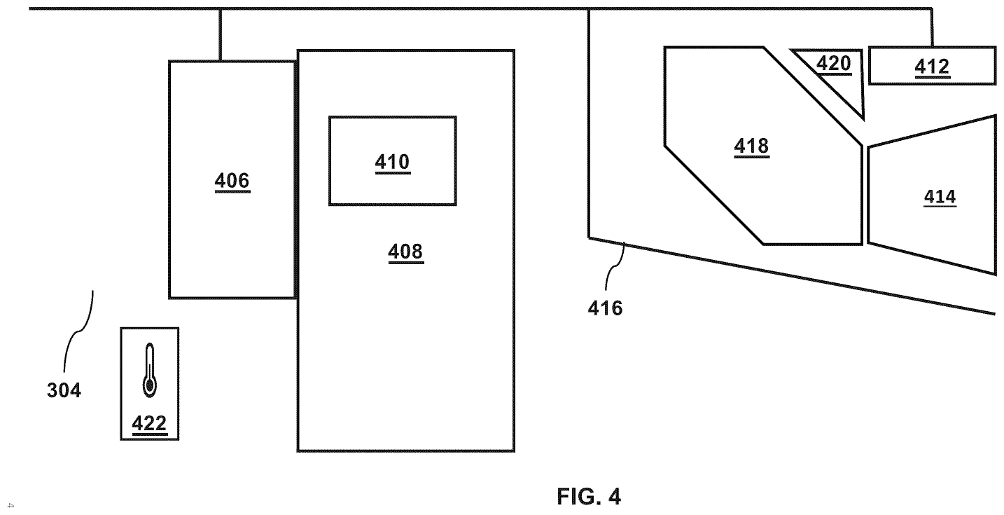

FIG. 4 also depicts a map of the location of interest 304, according to a preferred embodiment of the present invention. The map comprises a set of features 406-420. The location also comprises a local weather station 422.

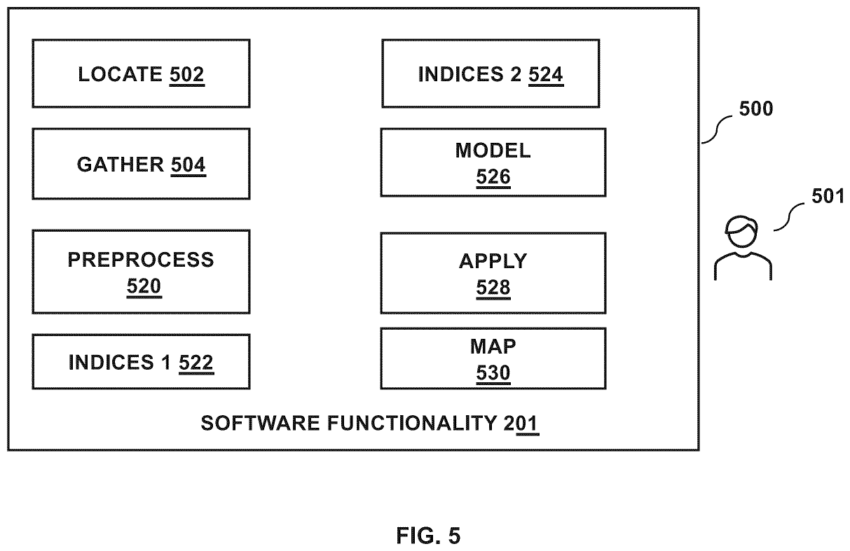

FIG. 5 depicts software components 500 used, including preprocess 520, indices 1 522, indices 2 524, model 526, apply 528, and map 530, according to a preferred embodiment of the present invention.

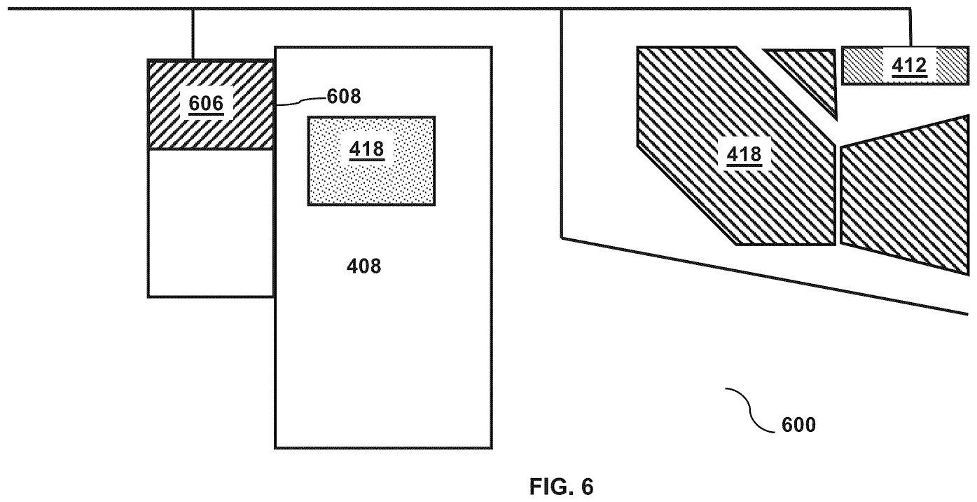

FIG. 6 depicts an annotated map 600 of the location 304 after processing, according to a preferred embodiment of the present invention.

In a preferred embodiment of the present invention, the metric to be evaluated is that of LST. The method starts at step 202. At step 204, a user 501 uses a locate component 502 to locate an asset in terms of latitude and longitude.

At step 206, the locate component 502 retrieves data about the location. For example, existing maps (for example, OpenStreetMap or Google Maps), and ground temperatures from any local weather stations 422.

At step 208, a gather component 504 gathers satellite images and spectral band data from Landsat 8/9 for the location of interest 304. In practice, images and spectral band data are available in products such as those supplied by USGS. Data is gathered from at least the spectral bands that are used to calculate the indices, and also thermal data from Landsat 8/9 band 10. Also at step 210, the gather component 504 gathers satellite images and spectral band data from Sentinel-2 for the location of interest 304. Data retrieval is made for the location of interest 304 as closely together in terms of observation time and cloud conditions, so is gathered for the same time period. The time period should be as short as possible. The more concurrent the readings are, the more accurate the target variable is. The skilled person would understand typically the time period is less than a day to provide images under similar environmental conditions, but the time period could comprise a span of minutes less than an hour, minutes more than an hour less than a day, or hours. Data retrieval may be made by any suitable tool, such as EO Browser https://www.sentinel-hub.com/explore/eobrowser (retrieved from Internet on 10 Apr. 2024).

At step 212, a preprocess component preprocesses the acquired data. Preprocessing comprises, downloading the scenes of interest, checking the images for quality, and making radiometric and geometric corrections. Quality checking is necessary to discard poor images, such as those with cloud cover. Corrections are made to account, for example, for sensor effects. Atmospheric corrections also need to be made for the thermal bands to convert radiance values to surface temperature values. There are a number of well-known algorithms, for example, the single-channel algorithm. Thermal band values are converted to LST using sensor specific calibration parameters. LST retrieval algorithms convert brightness temperature values to LST values, taking into account land cover type, emissivity etc. Landsat 8/9 and Sentinel-2 were developed collaboratively, so that reflectance values from each are generally compatible with each other. However, equivalent wavelength ranges for Sentinel-2 and Landsat 8/9 are not quite the same. For example, Band 3 Green for Sentinel-2 and Landsat 8/9 have wavelengths 543-578 nm and 525-600 nm respectively. Therefore, when using values, corrections need to be made. Tools are available to make such corrections. Corrections are also made to compensate for differing conditions at the location of interest 304 when the respective satellites acquired data. Data preprocessing may be necessary to handle missing values, outliers or any other inconsistency.

At step 214, a first indices component 522 calculates various well known indices in optical satellite channels based on data gathered at a first resolution from Landsat 8/9. For Landsat 8/9 resolution is typically 30 m, as shown in Table 1. In a preferred embodiment, the indices calculated are: NDVI₃₀ₘ; NDWI₃₀ₘ; NDBI₃₀ₘ; NDSI₃₀ₘ; and NBRI₃₀ₘ. For the benefit of doubt, subscripts to indices signify the resolution of the indices. The LST value is calculated at 30 m resolution using the Landsat 8/9 band 10 data, by converting thermal radiance to LST, for example by using the radiative transfer equation as is known in the art (for example, Rajeshwari A, Mani N D. 2014. “Estimation of land surface temperature of Dindigul district using LANDSAT-8” Int J Res Eng Technol. 03:122-126.) In an alternative embodiment, the LST value is calculated at 30 m resolution using the Landsat 8/9 band 11 data.

Although NDSI, and NBRI relate to snow and burn indices, their use has been found to provide particular correlation for assessing heat loss and CO₂ emissions from buildings.

At step 216, a second indices component 524 calculates the indices in optical satellite channels based on data gathered at a second resolution from Sentinel-2. Sentinel-2 satellites provide imagery at different spatial resolutions for various spectral bands:
10-meter resolution for Bands 2, 3, 4, and 8 (VNIR bands).
20-meter resolution for Bands 5, 6, 7, 8A, 11, and 12 (NIR and SWIR bands).
60-meter resolution for Bands 1 and 9 (coastal aerosol and water vapor bands).

In a preferred embodiment, the indices calculated are: NDVJ₁₀ₘ; NDWL₁₀ₘ; NDBJ₁₀ₘ; NDSJ₁₀ₘ; and NBRJ₁₀ₘ.

At step 218, a model component 526 generates a linear regression model which utilizes the indices from step 214 and uses the thermal band as its objective. The purpose of the generated regression models is to establish relationships between the low-resolution LST data and the high-resolution environmental indices.

The formula for multiple linear regression describes the relationship between a dependent variable (Y) and two or more independent variables (X₁, X₂, . . . , Xₚ).

$$Y = {β}_{0} + {β}_{1} {X}_{1} + {β}_{2} {X}_{2} + … + {β}_{p} {X}_{p} + ϵ \qquad Equation 13$$

Where:
   Y is the dependent variable (also called the response variable, target or outcome).
   X₁, X₂ . . . , Xₚ are the independent variables (also called predictor variables or features).
   β₀ is the intercept term, representing the expected value of Y when all the independent variables are zero.
   β₁,β₂ . . . , βₚ are the regression coefficients, representing the change in Y associated with a one-unit change in each independent variable, holding all other variables constant.
   ϵ is an error term, representing the variability in Y that cannot be explained by the independent variables.

The coefficients β₀, β₁ . . . , βₚ are estimated from the data using a method such as ordinary least squares (OLS) regression. The goal of multiple linear regression is to find the coefficients that minimize the sum of squared differences between the observed and predicted values of the dependent variable.

To determine the factors in a multivariable regression line a number of techniques may be used, such as statistical software. The aim is to estimate the regression coefficients βₙ, that best fits the data and minimises the sum of square residuals.

Applying this equation to the calculated indices:

$${LST}_{30 m} = {β}_{0} + {β}_{1} {NDVI}_{30 m} + {β}_{2} {NDWI}_{30 m} + {β}_{3} {NDBI}_{30 m} + {β}_{4} {NDSI}_{30 m} + {β}_{5} {NBRI}_{30 m} + ϵ \qquad Equation 14$$

Solving Equation 14, for example, using the R Project for Statistical Computing, gives the coefficients βₙ. In developing the regression model, calibration may include a training dataset comprising paired observations of low-resolution LST and high-resolution environmental variables. The model parameters are adjusted to minimize the difference between the observed and predicted values of LST in the training dataset. This process may involve techniques such as least squares estimation, maximum likelihood estimation, or regularization methods to prevent overfitting.

Validation is made by evaluating the model against a validation dataset, which was not used during model calibration. Typical metrics used to evaluate models are: root mean square error (RMSE), mean absolute error (MAE), coefficient of determination (R²), and Mean Absolute Percentage Error (MAPE).

MAPE evaluates the accuracy of forecasting models or predictive models. MAPE measures the average absolute percentage difference between the predicted values and the actual values. It is expressed as a percentage.

$$MAPE = ( \frac{100}{n} ) {\sum }_{t = 1}^{n} \vert ( At - Ft ) / At \vert \qquad Equation 15$$

Where:
n is the number of observations.
At is the actual value at time t.
Ft is the forecasted (predicted) value at time t.

MAPE values range from 0% to positive infinity. A lower MAPE indicates better accuracy, with 0% indicating perfect accuracy (i.e., the predicted values match the actual values exactly). However, MAPE should be used with caution, especially when dealing with small actual values or when the denominator (actual value) approaches zero, as it can lead to undefined or misleading results.

MAPE is commonly used in various fields, including economics, finance, supply chain management, and demand forecasting, to assess the performance of forecasting models and improve decision-making processes.

At step 220 an apply component 220 applies the model using the indices calculated in step 216 to predict the value of the dependent variable for new observations by substituting the values of the independent variables into the equation.

$${LST}_{10 m} = {β}_{0} + {β}_{1} {NDVI}_{10 m} + {β}_{2} {NDWI}_{10 m} + {β}_{3} {NDBI}_{10 m} + β 4 {NDSI}_{10 m} + β 4 {NBRI}_{10 m} + {ϵ}_{10 m} \qquad Equation 16$$

Where ϵ₁₀ₘ=Y₃₀ₘ−Y_{obs}
ϵ₁₀ₘ is resampled to ϵ₁₀ₘ as a 10 m cell size grid by convolution with a Gaussian kernel of 30 m size in ArcMap

At step 222, a map component generates a new thermal image at 10 m resolution. FIG. 6 depicts a pictorial representation of location of interest 304, after the downscaling. Typically, such images are provided in color, but for illustration purposes, patterns have been provided.

Area 606 depicts heat loss from building 408 through entrance 608. Area 418 depicts solar panels on building 408. Areas 414, 418, 420 depict a solar farm, and area 412 depicts a control building for the solar farm. Although not depicted, the metrics and images can then be applied in real time to drive thermal efficiencies in buildings. For example, a metric may show that there is heat loss coming from open windows, so that automatic mechanisms can be activated to close them.

At step 299, the method ends.

That this technique increases in effectiveness if the images are captured during the winter months of that hemisphere.

In an alternative embodiment the inclusion of at least one: EVI, SAVI, NDMI, MSI, GCI, BSI and ARVI would improve the quality of the model fit as this incorporates more available optical channels and gives a large set of points to interpolate over.

Preferably, measurements are made during winter months when the effects of heat loss are most keenly felt.

In an alternative embodiment, indices are chosen to factor in the geographical location of interest. For example, BSI may be more suited for hot climates, such as Western Australia. In this embodiment, the locate component 502 chooses a further index from the list of indices, for example, EVI, SAVI, NDMI, MSI, GCI, BSI and ARVI, based on analyzing a climate of the location.

In an alternative embodiment, the model is developed using other techniques such as a Random Forest machine learning algorithm used for classification and regression tasks. In an alternative embodiment, non-linear regression models may be developed to describe the correlation between indices and metric.

In alternative embodiment, the metric to be evaluated is that of CO₂. In this embodiment, the CO₂ value is calculated at 30 m resolution using the Landsat 8/9 band 11 data. Studies have shown that Band 11 correlates significantly with CO₂ values, because band 11 is close to the 15 μm band of CO₂, in which CO₂ molecules absorb and emit infrared radiation.

Remote sensing instruments that operate in the 15 μm spectral region, such as Fourier-transform infrared (FTIR) spectrometers or passive infrared radiometers, can measure the intensity of radiation absorbed by atmospheric CO₂.

As with LST, in step 218 a model can be developed:

$${CO}_{2 - 30 m} = {α}_{0} + {α}_{1} {NDVI}_{30 m} + {α}_{2} {NDWI}_{30 m} + {α}_{3} {NDBI}_{30 m} + {α}_{4} {NDSI}_{30 m} + {α}_{5} {NBRI}_{30 m} + η \qquad Equation 17$$

Where:
CO₂₋₃₀ₘ is the dependent variable
NDVI₃₀ₘ, NDWI₃₀ₘ, NDBI₃₀ₘ, NDSI₃₀ₘ, NBRI₃₀ₘ are the independent variables
α₀ is the intercept term, representing the expected value of CO₂₋₃₀ₘ when all the independent variables are zero.
α₁, -α₅ are the regression coefficients, representing the change in CO₂₋₃₀ₘ associated with a one-unit change in each independent variable, holding all other variables constant.
η is an error term, representing the variability in CO₂₋₃₀ₘ that cannot be explained by the independent variables.

At step 220 the apply component 220 applies the model using the indices calculated in step 216 to predict the value of the dependent variable for new observations by substituting the values of the independent variables into the equation.

$${CO}_{2 - 10 m} = {α}_{0} + {α}_{1} {NDVI}_{10 m} + {α}_{2} {NDWI}_{10 m} + {α}_{3} {NDBI}_{10 m} + {α}_{4} {NDSI}_{10 m} + {α}_{5} {NBRI}_{10 m} + {η}_{10 m} \qquad Equation 18$$

$$Where {η}_{10 m} = {CO}_{2 - 30 m} - {CO}_{2 - obs}$$

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein. It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above invention may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

Moreover, the same or similar reference numbers are used throughout the drawings to denote the same or similar features, elements, or structures, and thus, a detailed explanation of the same or similar features, elements, or structures will not be repeated for each of the drawings. The terms “about” or “substantially” as used herein with regard to thicknesses, widths, percentages, ranges, etc., are meant to denote being close or approximate to, but not exactly. For example, the term “about” or “substantially” as used herein implies that a small margin of error is present. Further, the terms “vertical” or “vertical direction” or “vertical height” as used herein denote a Z-direction of the Cartesian coordinates shown in the drawings, and the terms “horizontal,” or “horizontal direction,” or “lateral direction” as used herein denote an X-direction and/or Y-direction of the Cartesian coordinates shown in the drawings.

Additionally, the term “illustrative” is used herein to mean “serving as an example, instance or illustration.” Any embodiment or design described herein is intended to be “illustrative” and is not necessarily to be construed as preferred or advantageous over other embodiments or designs.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

For the avoidance of doubt, the term “comprising”, as used herein throughout the description and claims is not to be construed as meaning “consisting only of”.

1. A method for determining a metric at a second resolution at a location, the method comprising:
gathering a first set of spectral values from a first satellite at a first resolution for the location in a first time period, the first set of spectral values comprising a value from a thermal band;
determining a set of indices at the first resolution and the metric at the first resolution from the first set of spectral values, wherein the set of indices comprises: NDVI; NDWI; NDBI; NDSI; and NBRI;
determining a model linking the metric at the first resolution with the set of indices at the first resolution;
acquiring a second set of spectral values from a second satellite at the second resolution for the location for the first time period, the second resolution finer than the first resolution;
determining the set of indices at the second resolution from the second set of spectral values; and
applying the second set of indices to the model to determine the metric at the second resolution.

2. The method of claim 1, wherein the first satellite comprises a Landsat satellite, and the second satellite comprises a Sentinel satellite.

3. The method of claim 2, wherein the metric comprises Land Surface Temperature, and the thermal band comprises Landsat band 10.

4. The method of claim 2, wherein the metric comprises CO₂ and the thermal band comprises Landsat band 11.

5. The method of claim 1, wherein the set of indices further comprises at least one from a list, the list comprising: EVI; SAVI; NDMI; MSI; GCI; BSI; and ARVI.

6. The method of claim 5, wherein the method further comprises:
choosing a list item based on analyzing climate of the location.

7. The method of claim 1, wherein determining a model comprises applying a multivariable regression line.

8. The method of claim 1, wherein determining a model comprises applying a random forest algorithm.

9. The method of claim 1, further comprising generating an image based on the metric at the second resolution.

10. A system for determining a metric at a second resolution at a location, the system comprising: a memory; at least one processor in communication with memory; and program instructions executable by one or more processor via the memory to perform a method comprising:
gathering a first set of spectral values from a first satellite at a first resolution for the location in a first time period, the first set of spectral values comprising a value from a thermal band;
determining a set of indices at the first resolution and the metric at the first resolution from the first set of spectral values, wherein the set of indices comprises: NDVI; NDWI; NDBI; NDSI; and NBRI;
determining a model linking the metric at the first resolution with the set of indices at the first resolution;
acquiring a second set of spectral values from a second satellite at the second resolution for the location for the first time period, the second resolution finer than the first resolution;
determining the set of indices at the second resolution from the second set of spectral values; and
applying the second set of indices to the model to determine the metric at the second resolution.

11. The system of claim 10, wherein the first satellite comprises a Landsat satellite, and the second satellite comprises a Sentinel satellite.

12. The system of claim 11, wherein the metric comprises Land Surface Temperature, and the thermal band comprises Landsat band 10.

13. The system of claim 11, wherein the metric comprises CO₂ and the thermal band comprises Landsat band 11.

14. The system of claim 10, wherein the set of indices further comprises at least one from a list, the list comprising: EVI; SAVI; NDMI; MSI; GCI; BSI; and ARVI.

15. The system of claim 14, wherein the method further comprises:
choosing a list item based on analyzing climate of the location.

16. The system of claim 10, wherein determining a model comprises applying a multivariable regression line.

17. The system of claim 10, wherein determining a model comprises applying a random forest algorithm.

18. The system of claim 10, further comprising generating an image based on the metric at the second resolution.

19. A computer program product for determining a metric at a second resolution at a location, the computer program product comprising a computer readable storage medium having program instructions embodied therewith, the program instructions executable by a processor to cause the processor to:
gather a first set of spectral values from a first satellite at a first resolution for the location in a first time period, the first set of spectral values comprising a value from a thermal band;
determine a set of indices at the first resolution and the metric at the first resolution from the first set of spectral values, wherein the set of indices comprises: NDVI; NDWI; NDBI; NDSI; and NBRI;
determine a model linking the metric at the first resolution with the set of indices at the first resolution;
acquire a second set of spectral values from a second satellite at the second resolution for the location for the first time period, the second resolution finer than the first resolution;
determine the set of indices at the second resolution from the second set of spectral values; and
apply the second set of indices to the model to determine the metric at the second resolution.

20. The computer program product of claim 19, wherein the first satellite comprises a Landsat satellite, and the second satellite comprises a Sentinel satellite.
